(19) United States
(12) Patent Application Publication
(10) Pub. No.: US 2018/0066530 A1
(43) Pub. Date: Mar. 8, 2018

(54) TURBOENGINE BLADING MEMBER

(71) Applicant: ANSALDO ENERGIA IP UK LIMITED, LONDON (GB)

(72) Inventors: Herbert BRANDL, WALDSHUT-TIENGEN (DE); Marcel KOENIG, WETTINGEN (CH); Mikhail PAVLOV, DIETIKON (CH)

(73) Assignee: ANSALDO ENERGIA IP UK LIMITED, LONDON (GB)

(21) Appl. No.: 15/697,102

(22) Filed: Sep. 6, 2017

(30) Foreign Application Priority Data
Sep. 7, 2016 (EP) 16187538.0

(51) Int. Cl. F01D 5/30; F01D 9/04

(52) U.S. Cl. CPC F01D 5/3053; F01D 9/041; F05D 2260/30; F05D 2230/60; F05D 2240/80; F05D 2220/32

(57) ABSTRACT

Disclosed is a turboengine blading member, having at least one platform member and at least one airfoil member. A receiver through opening extends through the platform member. The connector post is received within the receiver through opening. Each of the connector post and the receiver through opening have a retainer flute provided on the circumferential wall and extending along at least a part of the circumferential extent. The retainer flutes are arranged juxtaposed each other with the open sides facing each other such as to jointly form a joint retainer cavity. First and second retainer members are bonded to each other to provide a common retainer member extending into both corresponding retainer flutes, thereby retaining the connector post within the receiver through opening and interlocking the airfoil member and the platform member.

### PRIORITY CLAIM

This application claims priority from European Patent Application No. 16187538.0 filed on Sep. 7, 2016, the disclosure of which is incorporated by reference.

### TECHNICAL FIELD

The present disclosure relates to a turboengine blading member as set forth in claim 1. It further relates to a method for assembling a turboengine blading member.

### BACKGROUND OF THE DISCLOSURE

It is known in the art to manufacture airfoil members and platform members of blading members of fluid flow machines separately and to assemble a blading member from at least one airfoil member and at least one platform member. This offers various benefits, e.g. different materials may be used for the airfoil and the platform, complexity of the individual pieces is reduced, thus allowing for more complex cooling schemes, and in providing individual geometries more suitable for casting or machining. However, airfoils and platforms need to be joined properly and reliably. Welding the airfoil member to a platform member is frequently not possible or at least found challenging due to the characteristics of high temperature materials which exhibit poor welding properties.

EP 1 176 284 proposes joining and interconnecting airfoils and platforms by brazing.

It may generally be stated that it may be found beneficial if the joint between the individual members of the blading member may easily be disassembled, preferably without damaging any of the members, and particularly not damaging the platform member. This facilitates for instance replacement of worn airfoils, while the platform member may be further used.

U.S. Pat. No. 5,797,725 discloses blading members wherein each of an airfoil member and a platform member comprise a corresponding flute which are filled by a common retainer. In a preferred embodiment the retainer is manufactured inside the flutes by casting, and in particular by a process referred to as bi-casting.

US 2009/0196761 describes joining airfoil and platform members by a so-called injection molding process.

The common concept disclosed in U.S. Pat. No. 5,797,725 and US 2009/0196761 is to provide a retainer cavity and manufacture in situ inside the retainer cavity a retainer member which retains a connector post of an airfoil member inside a receiver opening of the platform member. The methods, while yielding good results, require extensive process know-how and equipment. They require pre-heating of the assembled components to elevated temperatures. This turns the application of said processes expensive and time-consuming.

### OUTLINE OF THE SUBJECT MATTER OF THE PRESENT DISCLOSURE

It is an object of the present disclosure to provide a turboengine blading member of the type initially mentioned. In particular, the turboengine blading member may be a blading member which is suitable for use as a static vane member or a rotating blade member. In another aspect, the turboengine blading member may be disclosed to be suitable for use in a gas turbine engine, and in particular in the hot gas path of the expansion turbine of a gas turbine engine. In a further aspect, a method for assembling a turboengine blading member shall be disclosed. The turboengine blading member disclosed herein as well as the herein disclosed method for assembling a turboengine blading member shall avoid any issues of in situ primary forming a retainer member. In particular, any issues potentially related to providing a liquid casting slip into a retainer cavity, wherein the retainer cavity extends into a connection post of the airfoil member as well as into a wall of the receiver opening of the platform member, and solidifying the liquid casting slip in situ inside the retainer cavity, shall be avoided.

This is achieved by the subject matter described in claim 1.

Further effects and advantages of the disclosed subject matter, whether explicitly mentioned or not, will become apparent in view of the disclosure provided below.

Accordingly, disclosed is a turboengine blading member, the blading member comprising at least one platform member and at least one airfoil member. The airfoil member comprises an airfoil which extends along a spanwidth from a first end to a second end. A connector post is attached to at least one of the first and second ends of the airfoil. The airfoil extends and cantilevers along the spanwidth direction from the connector post. The platform member comprises a first face and a second face, and a receiver through opening extending from the first face to the second face. The connector post is received within the receiver through opening.

Each of the connector post and the receiver through opening exhibit a circumferential wall, and a joint gap is formed between said walls. Each of the connector post and the receiver through opening comprise a retainer flute provided on the circumferential wall and extending along at least a part of the circumferential extent. For each retainer flute provided on the circumferential wall of one of the connector post and the receiver through opening, a corresponding flute is provided on the circumferential wall of the other one of the connector post and the receiver through opening. Within each pair of corresponding retainer flutes, the retainer flutes are arranged juxtaposed each other with the open sides facing each other such as to jointly form a joint retainer cavity. A first retainer member is provided in one of the corresponding retainer flutes. A second retainer member is provided in the other one of the corresponding retainer flutes. The first and second retainer members are bonded to each other to provide a common retainer member extending into both corresponding retainer flutes, thereby retaining the connector post within the receiver through opening and interlocking the airfoil member and the platform member.

A method for assembling a turboengine blading member accordingly comprises providing an airfoil member and a platform member. The airfoil member comprises an airfoil extending along a spanwidth from a first end to a second end, a connector post being attached to at least one of the first and second ends of the airfoil. The airfoil extends and cantilevers along the spanwidth direction from the connector post. The platform member comprises a first face and a second face, and a receiver through opening extending from the first face to the second face.

Each of the connector post and the receiver through opening exhibit a circumferential wall. A retainer flute is provided on the circumferential wall of the connector post and a retainer flute is provided on the circumferential wall of the receiver through opening. The method further comprises inserting a first retainer member into the retainer flute of the connector post, inserting a second retainer member into the retainer flute of the receiver through opening, joining the airfoil member and the platform member in inserting the connector post into the receiver through opening, whereby a joint gap is formed between the circumferential walls of the connector post and the receiver through opening, and aligning the retainer flute of the connector post and the retainer flute of the receiver through opening such as to provide a joint retainer cavity. Thereby also the first and the second retainer members are aligned inside the joint retainer cavity. The first and the second retainer members are bonded to each other such as to provide a common retainer member which extends into both aligned retainer flutes. It is readily understood that the common retainer member thus retains the connector post inside the receiver through opening and interlocks the assembly of the airfoil member and the platform member.

It is noted that within the framework of the present disclosure the use of the indefinite article “a” or “an” does in no way stipulate a singularity nor does it exclude the presence of a multitude of the named member or feature. It is thus to be read in the sense of “at least one” or “one or a multitude of”.

As the skilled person will readily appreciate, the method comprises inserting the constituents of the common retainer member into the retainer flutes before joining the platform member and the airfoil member. Thus, no access aperture is required to introduce a retainer member into the assembly of the platform member and the airfoil member. Primary shaping of the retainer member is not performed in situ inside the assembled components. Heat intake into the components during the interlocking process is largely reduced when compared to methods wherein the retainer member is primarily shaped in situ by e.g. a casting process.

It will be appreciated that in the assembled blading member the airfoil extends and cantilevers from a face or side of a blade platform which comprises a side or face of the platform member. It will further be appreciated that this face or side of the platform member is intended to be exposed to the working fluid of a turboengine. This side or face may be referred to as the hot gas side of the platform, while the opposed side or face may be referred to as the cool fluid side.

Bonding the retainer members may comprise applying a material bonding method, and in particular welding. In another aspect, bonding the retainer members may comprise accessing the bonding location through the joint gap. It may further comprise guiding one of a laser beam and an electron beam through the joint gap to the bonding location between the retainer members.

When bonding the retainer members by electron beam welding, the method may comprise placing the assembly of the platform member and the airfoil member into a vacuum chamber and evacuating the vacuum chamber before applying the electron beam welding step. Otherwise, it is appreciated that the welding step may be performed in an inert, protective gas atmosphere. In one aspect, the assembly may be placed in a protective gas filled vessel. In another aspect, the joint gap may be covered and sealed with a membrane to produce a closed volume in which the welding step is applied. This volume may then be purged with an inert protective or shielding gas. In providing a limited closed volume, the application of special laser welding gas mixtures, such as, but not limited to, helium, argon, carbon dioxide, nitrogen, and other inert gases, and mixtures thereof, is very efficient. To that extent, two purging apertures may be provided in fluid communication with the joint retainer cavity through which a purging flow of shielding gas may be provided across the weld seam over the entire extent of the retainer members, or the contact seam of the retainer members, respectively. It is appreciated that the purging flow also serves to remove fumes from the welding location, such that a welding laser beam is not attenuated by said fumes, and the process may be performed with a controlled welding laser power intake to the welding location.

In more specific embodiments, a beveled shoulder is provided on the connector post at which a cross section of the connector post tapers from a first end to a second end, and a beveled shoulder is provided inside the receiver through opening at which a cross section of the receiver through opening tapers from one of the first and second faces of the platform member to the other one of the first and second faces of the platform member. The corresponding beveled shoulders are provided abutting each other. Assembled blading members with such abutting beveled shoulders are for instance disclosed in EP 3 034 800, the respective and relevant content thereof being included by reference and constituting an integral part of the present disclosure. It will be appreciated, that the corresponding abutting beveled shoulders may provide a sealing arrangement and may thus inhibit fluid leakages through the joint gap from one of the first and second faces to the other one of the first and second faces. Coolant leakages and/or hot working fluid ingestion may thus be avoided or at least be significantly reduced.

The joint retainer cavity and the common retainer member may in certain instances be disposed towards the hot gas side of the platform member when seen from the abutting beveled shoulders. In other instances, however, the joint retainer cavity and the common retainer member may be disposed towards the cool fluid side of the platform member when seen from the abutting beveled shoulders. The latter embodiment may yield the advantage that the abutting beveled shoulders may provide a seal, and thus contact of the common retainer member with the turboengine working fluid through the joint gap, which may lead to an enhanced heat intake into the common retainer member, may be avoided.

The method for assembling the turboengine blading member may accordingly comprise providing the connector post with a beveled shoulder at which a cross section of the connector post tapers from a first end to a second end, and providing the receiver through opening with a corresponding mating beveled shoulder at which a cross section of the receiver through opening tapers from a first one of the faces of the platform member to a second one of the faces of the platform member. The method may then further comprise inserting the connector post into the receiver through opening from said first one of the faces of the platform member in inserting the connector post into the receiver through opening with the second end of the connector post first, and mating the beveled shoulders.

It is understood, that the joint gap comprises a first joint gap section extending from the retainer cavity towards one face of the platform member and a second joint gap section extending from the retainer cavity towards the other face of the platform member. In certain embodiments, the first and the second joint gap sections may exhibit different gap widths. As is readily appreciated, in particular the one of said joint gap sections exhibiting the larger gap width may extend straight to an end of the joint gap and be open towards the exterior of the blading member. Thus, the retainer cavity, and the retainer members provided therein, are accessible from one face of the platform member, in particular to perform the bonding step between the retainer members. For instance, an electron beam or a laser beam for welding purposes may be guided through said joint gap section exhibiting the larger gap width.

In further more specific embodiments, a beveled shoulder is provided on the connector post at which the cross section of the connector post tapers from a first and to a second end, and a beveled shoulder is provided inside the receiver through opening at which a cross section of the receiver through opening tapers from one of the first and second faces of the platform member to the other one of the first and second faces of the platform member. Said beveled shoulders are provided abutting each other. The second joint gap section may extend from the retainer cavity to the abutting shoulders, whereas the first joint gap section extends from the retainer cavity towards a face of the platform member and is open towards said face, wherein the first gap section is wider, that is, exhibits a larger gap width, than the second joint gap section in order to provide bonding access to the retainer members. The skilled person will readily appreciate that a fluid tight sealing may thus be provided on the side of the retainer cavity from which the second joint gap section extends, as this joint gap section is terminated by the abutting beveled shoulders which may provide said fluid tight sealing.

In further more specific embodiments, the first joint gap section which extends from the retainer cavity towards one face of the platform member and the second joint gap section extending from the retainer cavity towards the other face of the platform member, may be provided laterally offset with respect to each other. One of the joint gap sections is provided aligned with the seam between the retainer members provided inside the retainer cavity, while the other joint gap section is not aligned with the seam between the retainer members provided inside the retainer cavity. It is understood that the joint gap section which is aligned with the seam is open towards the exterior of the blading member, and may exhibit a larger gap width that the joint gap section which is not aligned. Thus, the aligned joint gap section provides bonding access to the retainer member.

In certain embodiments, a spring member may be provided at the ground of at least one retainer flute and between the ground of the retainer flute and the respective retainer member. The spring member may be provided to exert a compressive force onto the mating surfaces of the retainer members provided inside the corresponding retainer flutes.

In further exemplary embodiments, the mating surfaces of the retainer members may be inclined with respect to the extent of the joint gap between the first and the second face of the platform member.

In still further aspects, the blading member may be provided with multiple airfoils. Accordingly, in certain instances the platform member may be provided with a multitude of at least two receiver through openings, a connector post of an airfoil member being received within each receiver through opening, and a connector post of each airfoil member being retained within a receiver through opening by a common retainer member being received within a joint retainer cavity.

Likewise, the blading member may be provided with a shroud. A connector post may be provided at each end of the airfoil such that the airfoil extends along the spanwidth between two connector posts. In this instance, a platform member may be provided at each end of the airfoil member, wherein the connector post at each end is received in and retained within a receiver opening of a respective platform member. At least one connector post is retained within a receiver through opening by a common retainer member being provided within a joint retainer cavity.

In further embodiments, it may be provided that at least two purging apertures are arranged in fluid communication with the joint retainer cavity. The purging apertures are provided moreover in fluid communication with an exterior of the blading member. The purging apertures are arranged to join the joint retainer cavity at locations which allow a purging fluid flow through at least essentially the entire length of the joint retainer cavity. It is understood that the purging apertures may be provided with a flow cross section which is significantly smaller than the cross section of the joint retainer cavity, and smaller than a cross section of the common retainer member, or any of the retainer members, respectively. Through said purging apertures an inert shielding gas purging flow may be provided inside the joint retainer cavity during the welding process, such that fumes are purged from the welding location. It will be readily appreciated that the shielding gas may then be introduced into the joint retainer cavity through a purging aperture and discharged through another purging aperture. Accordingly, an embodiment of the method for assembling a blading member is disclosed.

It is understood that for reconditioning purposes the bonded common retainer member may be cut through the same joint gap section through which the welding access was provided. For instance, a cutting laser or an appropriate cutting tool may be introduced through said gap to the common retainer member to cut the retainer member such that the blading member and the platform member may be disassembled.

It is further understood that the receiver through opening and the connector post may exhibit at least largely congruent cross sectional geometries, and may be complementarity to each other. The cross sectional geometry of any of the receiver through opening and the connector post, and in particular both the receiver through opening and the connector post, may be generally airfoil-shaped.

At least one retainer flute may in certain embodiments be provided as a circumferential retainer flute which extends as a closed loop around the entire circumference of the connector post and/or the receiver through opening. Likewise, at least one retainer member may in certain embodiments be provided as a circumferential retainer member which extends as a closed loop inside a retainer flute and around the entire circumference of the connector post and or the receiver through opening. It is however conceivable that a multitude of at least two individual retainer members are provided along said circumferential extents.

It is understood that the features and embodiments disclosed above may be combined with each other. It will further be appreciated that further embodiments are conceivable within the scope of the present disclosure and the claimed subject matter which are obvious and apparent to the skilled person.

### BRIEF DESCRIPTION OF THE DRAWINGS

The subject matter of the present disclosure is now to be explained in more detail by means of selected exemplary embodiments shown in the accompanying drawings. The figures show

FIG. 1 a schematic depiction of the insertion of two retainer members in a joint retainer cavity and joining the two retainer members to provide a common retainer member;

FIG. 2 an exemplary embodiment of a blading member according to the teaching of the present disclosure;

FIG. 3 a second exemplary embodiment of a blading member according to the teaching of the present disclosure;

FIG. 4 a third exemplary embodiment of a blading member according to the teaching of the present disclosure;

FIG. 5 a forth exemplary embodiment of a blading member according to the teaching of the present disclosure; and

FIG. 6 a cross sectional view of an interface between a platform member and an airfoil member.

It is understood that the drawings are highly schematic, and details not required for instruction purposes may have been omitted for the ease of understanding and depiction. It is further understood that the drawings show only selected, illustrative embodiments, and embodiments not shown may still be well within the scope of the herein disclosed and/or claimed subject matter.

### EXEMPLARY MODES OF CARRYING OUT THE TEACHING OF THE PRESENT DISCLOSURE

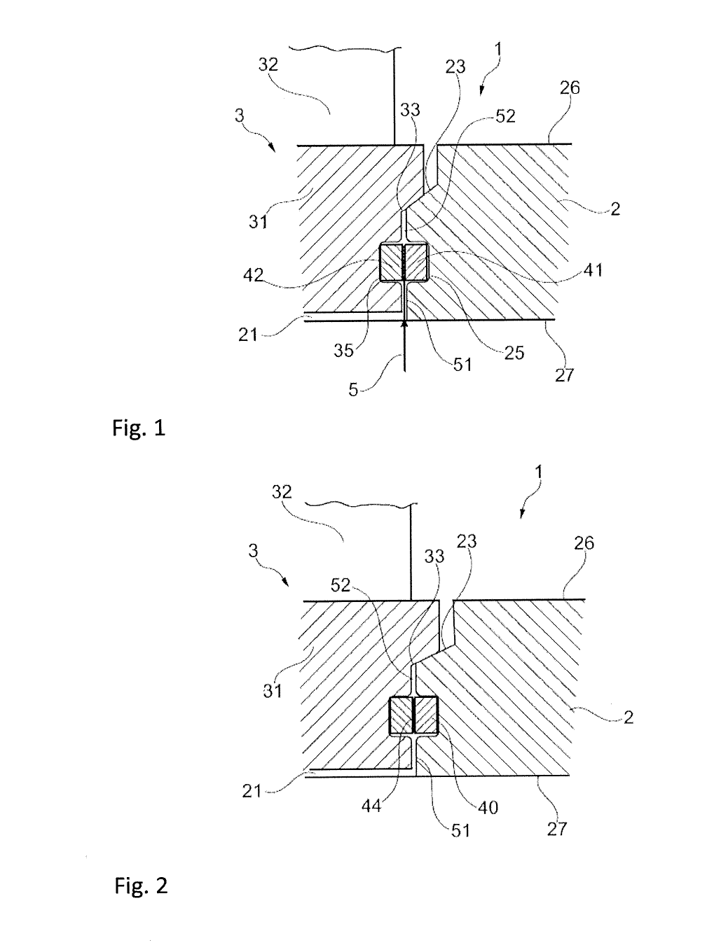

In FIGS. 1 and 2, the process for interlocking the airfoil member and the platform member of a blading member according to the present disclosure is illustrated. With reference to FIG. 1, blading member 1 comprises a platform member 2 and an airfoil member 3. Airfoil member 3 comprises connector post 31 and airfoil 32 extending and cantilevering from connector post 31. Platform member 2 comprises receiver through opening 21. Connector post 31 is received inside receiver through opening 21. Platform member 2 comprises a first face 26, which is arranged on a side of the platform member, or the blading member, respectively, where the airfoil is provided. The side is intended to be exposed to the working fluid of a turboengine and is referred to as the hot fluid side. Further, platform member 2 comprises a second face 27 which is provided opposite first face 26.

The side of the platform member or the blading member, respectively, on which second face 27 is provided, may be referred to as the cool fluid side. Platform member 2 comprises beveled shoulder 23 provided on an inner wall of receiver through opening 21. Airfoil member 3 comprises corresponding beveled shoulder 33 provided on an outer circumferential wall of connector post 31. Both beveled shoulders are beveled at at least essentially identical bevel angles, which may for instance not deviate more than 5° from each other. The surfaces of the beveled shoulders may be plan surfaces, or the surface of at least one of the beveled shoulders may be provided as a crowned surface. The beveled shoulders 23 and 33 abut each other while connector post 31 is received within receiver through opening 21. A retainer flute 25 is provided on an inner wall delimiting receiver through opening 21. A corresponding retainer flute 35 is provided on an outer circumferential wall of connector post 31. Retainer flutes 25 and 35 are arranged juxtaposed each other and with their open sides facing each other to form a joint retainer cavity. A first retainer member 41 is provided inside retainer flute 25. A second retainer member 42 is provided within retainer flute 35. Retainer members 41 and 42 abut each other at mating surfaces thereof. A joint gap is formed between connector post 31 and an inner wall delimiting receiver through opening 21. The joint gap comprises a first joint gap section 51 extending from the joint retainer cavity towards the cool fluid side, and which is open on cool fluid side. A second joint gap section 52 extends from the joint retainer cavity towards the hot fluid side of the blading member and to the abutting shoulders 23 and 33. Second joint gap section 52 is terminated by the abutting shoulders 23 and 33. A welding beam 5, for instance a laser beam or electron beam, may be introduced from the cool fluid side through open first joint gap section 51, and be applied to bond retainer members 41 and 42 to form a common retainer member which is received in both retainer flutes 25 and 35. It is understood that the location of the mating surfaces of retainer members 41 and 42 to this extent needs to be aligned with open first joint gap section 51. It may be provided that joint gap sections 51 and 52 exhibit different gap widths. For instance, the joint gap section which is open towards a face of the platform member may be provided with a relatively larger gap width to facilitate welding beam access to the mating surfaces of the retainer members.

With reference to FIG. 2, a common retainer member 40 is provided inside the joint retainer cavity. Common retainer member 40 comprises a seam 44 at which the first and second retainer members are bonded together. Through common retainer member 40, extending into both retainer flutes, connector post 31 is retained inside the receiver through opening 21, and platform member 2 and airfoil member 3 are interconnected to jointly form blading member 1.

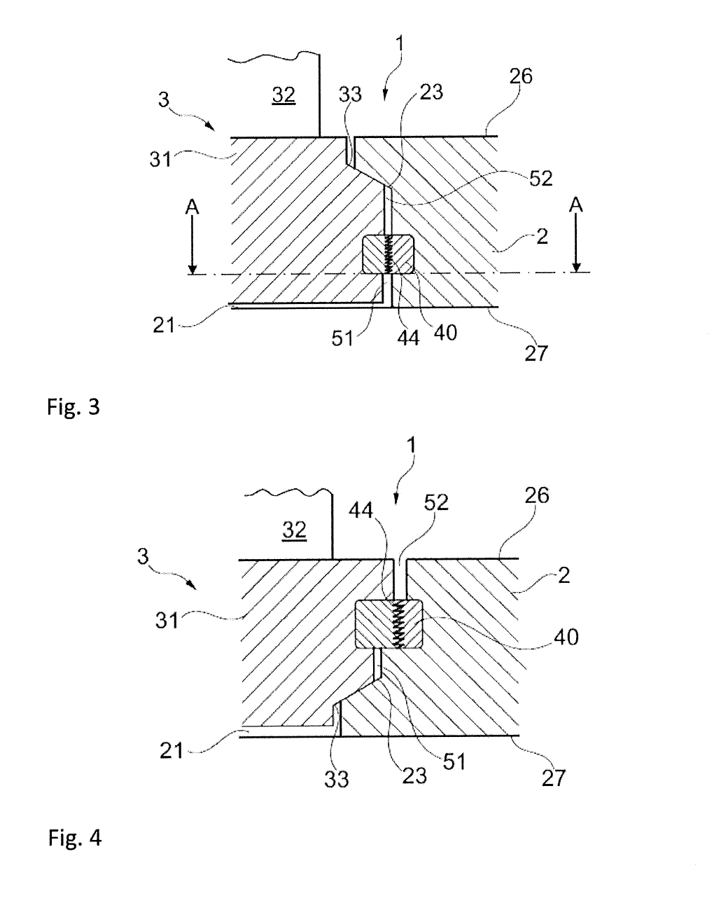

FIG. 3 illustrates a further embodiment, which is quite similar to that of FIGS. 1 and 2, with the difference that the arrangement of the abutting beveled shoulders has been reversed. As will be appreciated, a force exerted onto airfoil member 3 in a direction towards airfoil 32 is supported by the abutting beveled shoulders. Such a force may for instance be a centrifugal force if blading member 1 is applied as a running blade member.

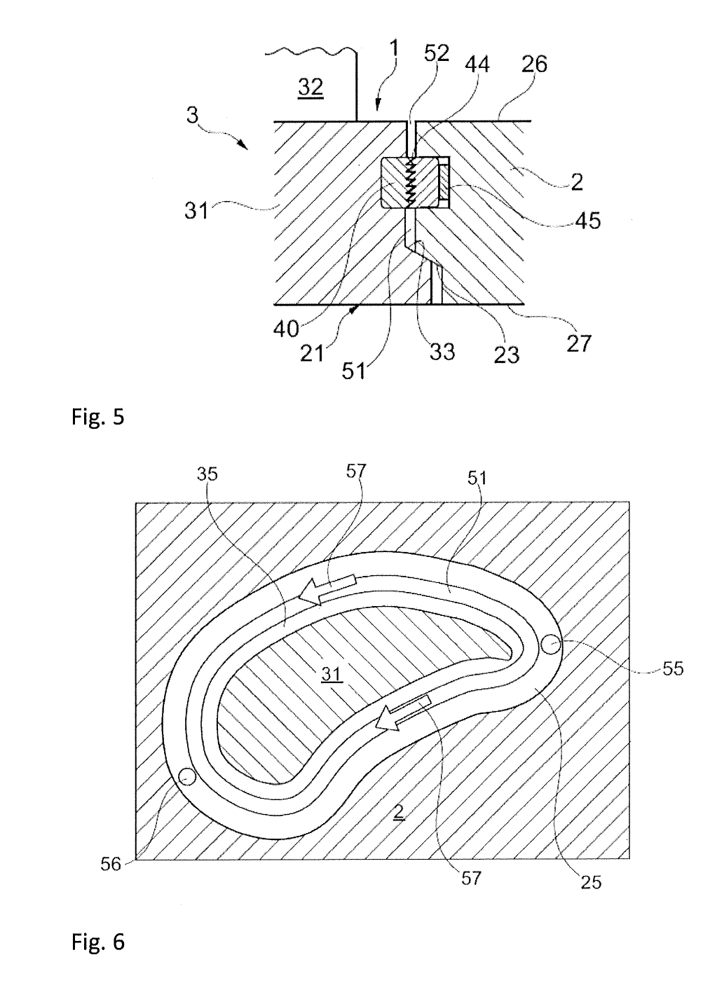

As is appreciated, in the embodiments of FIGS. 1 through 3 the joint retainer cavity and the common retainer member are disposed towards the cool fluid side of the platform, or the blading member, respectively, when seen from the abutting beveled shoulders. With reference to FIGS. 4 and 5, further embodiments are illustrated in which the joint retainer cavity and the common retainer member are disposed towards the hot gas side of the blading member when seen from the abutting beveled shoulders. As the skilled person will readily appreciate by virtue of FIGS. 1 through 3, those embodiments yield the advantage that the abutting beveled shoulders may provide a sealing against contact of the common retainer member with turboengine working fluid, and may thus considerably reduce thermal loading on the retainer arrangement. However, also the relative arrangement of the joint retainer cavity and the common retainer member as shown in the embodiments of FIGS. 4 and 5 may yield certain specific advantages. Also, while in the embodiments of FIGS. 1 through 3 the welding beam is applied from the cool fluid side, in the embodiments of FIGS. 4 and 5 the access for the welding beam is from the hot fluid side.

With respect to FIG. 4 it is seen that the first and second joint gap sections are in this instance laterally offset with respect to each other. This may yield the advantage that a force exerted on airfoil member 3 in a direction where it is not supported by the abutting beveled shoulders is supported by one of the individual retainer members instead of exerting shear stresses on weld seam 44.

In the embodiment of FIG. 5, a spring member 45 is provided on the bottom of one of the retainer flutes and is provided to exert a compressive force on the mating surfaces of the retainer members, or on the weld seam 44 of common retainer member 40, respectively.

It is noted that all embodiments of FIGS. 1 through 5 have been shown with abutting beveled shoulders. However, embodiments without abutting beveled shoulders are conceivable. The abutting beveled shoulders may provide a stop when inserting the connector post into the receiver through opening, and thus facilitate matching the positions of the retainer flutes. They may moreover serve to support certain forces. They may moreover serve to provide a sealing to avoid contact of the retainer member with hot working fluid of the turboengine, or other fluid leakage through the joint gap.

Finally, FIG. 6 shows a cross section taken, for instance, through the embodiment of FIG. 3 along line A-A. As becomes visible in this aspect, connector post 31 and the receiver through opening of platform member 2 exhibit the general shape of airfoils. This is a common, however not a mandatory, feature. The receiver through opening and connector post 31 exhibit at least essentially complementary shapes, such that connector post 31 is received within the receiver through opening with a joint gap formed between the respective walls thereof, wherein first joint gap section 51 is visible in the present depiction. Further, ledges delimiting retainer flutes 25 and 35 are visible. Two purging apertures 55 and 56 are provided in fluid communication with the retainer cavity, and in particular on the side from which access for the welding beam is provided. During the welding process, an inert shielding or protective gas flow may be introduced through purging aperture 55, and be discharged through purging aperture 56, thereby generating a purging flow as indicated by the arrows at 57. Said purging flow of shielding gas serves to purge the fumes which may arise during the welding process, and which might otherwise attenuate a welding laser beam.

While the subject matter of the disclosure has been explained by means of exemplary embodiments, it is understood that these are in no way intended to limit the scope of the claimed invention. It will be appreciated that the claims cover embodiments not explicitly shown or disclosed herein, and embodiments deviating from those disclosed in the exemplary modes of carrying out the teaching of the present disclosure will still be covered by the claims.

### LIST OF REFERENCE NUMERALS

1 blading member

2 platform member

3 airfoil member

5 welding beam

21 receiver through opening

23 beveled shoulder

25 retainer flute

26 first face of platform member, hot fluid side

27 second face of platform member, cool fluid side

31 connector post

32 airfoil

33 beveled shoulder

35 retainer flute

40 common retainer member

41 retainer member

42 retainer member

44 seam, weld seam

45 spring member

51 joint gap section

52 joint gap section

55 purging aperture

56 purging aperture

57 purging flow

1. A turboengine blading member, the blading member comprising:
at least one platform member;
at least one airfoil member, the airfoil member having an airfoil extending along a spanwidth from a first end to a second end;
a connector post attached to at least one of the first and second ends of the airfoil, wherein the airfoil extends along the spanwidth direction from the connector post,
the platform member having a first face and a second face, and a receiver through opening extending from the first face to the second face, wherein the connector post is received within the receiver through opening, each of the connector post and the receiver through opening exhibiting a circumferential wall, with a joint gap being formed between said walls;
wherein each of the connector post and the receiver through opening include a retainer flute provided on the circumferential wall and extending along at least a part of the circumferential extent, wherein for each retainer flute provided on the circumferential wall of one of the connector post and the receiver through opening a corresponding retainer flute is provided on the circumferential wall of the other one of the connector post and the receiver through opening, within each pair of corresponding retainer flutes the retainer flutes being arranged juxtaposed each other with the open sides facing each other such as to jointly form a joint retainer cavity; and
a first retainer member provided in one of the corresponding retainer flutes, a second retainer member provided in the other one of the corresponding retainer flutes, the first and second retainer members being bonded to each other to provide a common retainer member extending into both corresponding retainer flutes, thereby retaining the connector post within the receiver through opening and interlocking the airfoil member and the platform member.

2. The blading member according to claim 1, comprising:
a beveled shoulder provided on the connector post at which a cross section of the connector post tapers from a first end to a second end; and
a beveled shoulder provided inside the receiver through opening at which a cross section of the receiver through opening tapers from one of the first and second faces to the other one of the first and second faces,
wherein said beveled shoulders are provided abutting each other.

3. The blading member according to claim 1, wherein the joint gap comprises:
a first joint gap section extending from the retainer cavity towards one face of the platform member; and
a second joint gap section extending from the retainer cavity towards the other face of the platform member, the first and the second joint gap sections having different gap widths.

4. The blading member according to claim 3, comprising:
a beveled shoulder provided on the connector post at which a cross section of the connector post tapers from a first end to a second end;
a beveled shoulder provided inside the receiver through opening at which a cross section of the receiver through opening tapers from one of the first and second faces to the other one of the first and second faces, said beveled shoulders being provided abutting each other; and
wherein the second joint gap section extends from the retainer cavity to the abutting shoulders, the first joint gap section extends from the joint retainer cavity towards a face of the platform member and is open towards said face, and wherein the first joint gap section is wider than the second joint gap section in order to provide bonding access to the retainer members.

5. The blading member according to claim 1, wherein the joint gap comprises:
a first joint gap section extending from the joint retainer cavity towards one face of the platform member; and
a second joint gap section extending from the joint retainer cavity towards the other face of the platform member, the first and the second joint gap sections being laterally offset with respect to each other.

6. The blading member according to claim 1, comprising:
a spring member provided between a ground of at least one retainer flute and a respective retainer member.

7. The blading member according to claim 1, comprising:
mating surfaces of the retainer members inclined with respect to an extent of the joint gap between the first and the second face of the platform member.

8. The blading member according to claim 1, wherein the platform member comprises:
a multitude of at least two receiver through openings, a connector post of an airfoil member being received within each receiver through opening and a connector post of each airfoil member being retained within a receiver through opening by a common retainer member being received within a retainer cavity.

9. The blading member according to claim 1, comprising:
a connector post provided at each end of the airfoil such that the airfoil extends along the spanwidth between two connector posts, a platform member being provided at each end of the airfoil member, wherein the connector post at each end is received in and retained within a receiver opening of a respective platform member, wherein at least one connector post is retained within a receiver through opening by a common retainer member being provided within a retainer cavity.

10. A method for assembling a turboengine blading member, the method comprising
providing an airfoil member and a platform member,
the airfoil member having an airfoil extending along a spanwidth from a first end to a second end, and a connector post being attached to at least one of the first and second ends of the airfoil, wherein the airfoil extends along the spanwidth direction from the connector post,
the platform member having a first face and a second face, and a receiver through opening extending from the first face to the second face, each of the connector post and the receiver through opening exhibiting a circumferential wall, a retainer flute being provided on the circumferential wall of the connector post and a retainer flute being provided on the circumferential wall of the receiver through opening;
inserting a first retainer member into the retainer flute of the connector post;
inserting a second retainer member into the retainer flute of the receiver through opening;
joining the airfoil member and the platform member in inserting the connector post into the receiver through opening, whereby a joint gap is formed between the circumferential walls of the connector post and the receiver through opening; and
aligning the retainer flute of the connector post and the retainer flute of the receiver through opening to provide a joint retainer cavity, thereby aligning the first and the second retainer member inside the joint retainer cavity, and bonding the first and the second retainer members to provide a common retainer member which extends into both aligned retainer flutes.

11. The method according to claim 10, wherein bonding the retainer members comprises:
applying a material bonding method.

12. The method according to claim 10, wherein bonding the retainer members comprises:
accessing a bonding location through the joint gap.

13. The method according to claim 12, comprising:
guiding one of a laser beam and an electron beam through the joint gap to the bonding location between the retainer members.

14. The method according to claim 13, comprising:
covering the joint gap and purging the gap with an inert gas.

15. The method according to claim 10, comprising:
providing the connector post with a beveled shoulder at which a cross section of the connector post tapers from a first end to a second end;
providing the receiver through opening with a corresponding mating beveled shoulder at which a cross section of the receiver through opening tapers from a first one of the faces of the platform member to a second one of the faces of the platform member;
inserting the connector post into the receiver through opening from said first one of the faces of the platform member;
inserting the connector post into the receiver through opening with the second end of the connector post first; and
mating the beveled shoulders.
